(19) United States
(12) Patent Application Publication
(10) Pub. No.: US 2010/0024847 A1
(43) Pub. Date: Feb. 4, 2010

(54) SEMICONDUCTOR WAFER CLEANING WITH DILUTE ACIDS

(76) Inventors: Ronald G. Breese, Whitefish, MT (US); Benjamin Shafer, Hungry Horse, MT (US); Dana R. Scranton, Kalispell, MT (US); Bruce J. Fender, Kalispell, MT (US)

Correspondence Address: PERKINS COIE LLP/SEMITOOL, PO BOX 1208, SEATTLE, WA, 98111-1208, US

(21) Appl. No.: 12/184,997

(22) Filed: Aug. 1, 2008

(51) Int. Cl. B08B 3/08; B08B 13/00

(52) U.S. Cl. 134/25.4; 134/28; 134/95.3

(57) ABSTRACT

In a method for cleaning wafers using ultra-dilute acids, the wafers are placed into a rotor in a process chamber. As the rotor spins, the wafers are with de-ionized water and ultra-dilute hydrofluoric acid. Ozone gas is introduced into the process chamber. The wafers are then sprayed with an ultra-dilute solution of hydrochloric acid. Ozone gas is purged from the chamber. The wafers are then rinsed and dried. The ultra-dilute acids may be used in water to acid concentrations on the order of about 1000-2400:1.

### BACKGROUND OF THE INVENTION

In manufacturing micro-scale devices from semiconductor wafers and similar workpieces, it is often necessary clean the wafer surface, before, during and/or after various processing steps.

In the past, surface cleaning has been performed in manual or automated wet benches using the well known RCA clean immersion process. The RCA clean process (originally developed at RCA or Radio Corporation of America) involves three basic immersion steps: removal of organic contaminants (known as organic clean), removal of a thin oxide layer (known as oxide strip), and then removal of ionic contamination (known as ionic clean).

The organic clean step typically uses a heated solution of ammonia (NH4OH), hydrogen peroxide (H2O2) and water. The second step typically uses a brief immersion in a solution of hydrofluoric acid (HF) and water. The third step typically uses a heated solution of hydrochloric acid (HCl), hydrogen peroxide and water. The hydrofluoric and hydrochloric acids generally are highly concentrated. Dilutions on the order of 10:1 are representative, although there are many variations of the basic RCA clean process.

Wet benches typically have a row of immersion tanks, and a mechanism for sequentially immersing a batch a workpieces into each tank. However, these systems have several disadvantages including relatively large consumption of process chemicals, such as acids, and large consumption of water, e.g., 30-35 liters for each wet bench tank, with a bath life of for example 2-4 hours. This consumption of process chemicals increases manufacturing costs, which ultimately increases the cost of the final product. Wet benches also generally require a large amount of clean room space. This results in higher manufacturing costs and other disadvantages. Wet bench processing can also typically be relatively slow and require extensive wafer movement, as the wafers must be moved between several different tanks to complete a single processing step. This tends to add to total production time.

Many chemicals used in wet bench processing, such as HF, HCl, H₂SO₄, and H₂O₂, are toxic, highly corrosive, expensive, and/or difficult to handle and dispose of. As a result, complex draining, recycling, and removal systems are often required for effectively handling and disposing of these used chemicals. Moreover, even when proper disposal procedures are followed, there is still a potential for the used chemicals to have a negative environmental impact. Accordingly, there is a need for processing machines and methods having less reliance on these types of chemicals.

Reducing consumption of water is also beneficial, especially in areas where clean water is becoming increasingly scarce. Disposing of waste water from manufacturing operations, in environmentally friendly ways, can often be difficult or costly. Accordingly, reducing water consumption in the manufacturing process is also important.

Spin/spray systems have also been used for wafer cleaning. In these types of systems, typically wafers are held in a spinning rotor and sprayed with chemical liquids and gases. Spin spray systems generally can require less space and use smaller amounts of chemicals in comparison to wet benches. However, even spin/spray systems still tend to use significant amounts of chemicals.

Accordingly, it is an object of the invention to provide an improved spin/spray wafer cleaning system.

### SUMMARY OF THE INVENTION

New cleaning or processing systems and methods, have now been invented to overcome the disadvantages described above. These new systems and methods provide for rapid and efficient wafer cleaning with far less chemical consumption in comparison to existing systems. The invention therefore provides for significant advances in the technology of manufacturing semiconductor wafers and similar workpieces. In a new wafer cleaning method, one or more wafers are placed into a rotor in a process chamber. The rotor spins the wafers. De-ionized water and ultra-dilute hydrofluoric acid are sprayed onto the wafers. Ozone gas is introduced into the process chamber. The wafers are then sprayed with an ultra-dilute solution of hydrochloric acid. Ozone gas is purged from the chamber and the wafers are rinsed and dried.

The invention resides as well in sub-combinations of the features described and in the individual components.

### BRIEF DESCRIPTION OF THE DRAWINGS

In the drawings, wherein the same reference number denotes the same element throughout the several views:

FIG. 1 is a front perspective view of a workpiece processing system with various covers removed for purpose of illustration.

FIG. 2 is rear perspective view of the processing system of FIG. 1.

FIG. 3 is a perspective view of a processing chamber assembly.

FIG. 4 is a perspective view of a rotor that may be used in the processing chamber assembly of FIG. 3.

FIG. 5 is a schematic diagram of a processing method.

FIG. 6 is a table showing an example of a cleaning process using dilute acids.

### DETAILED DESCRIPTION OF THE DRAWINGS

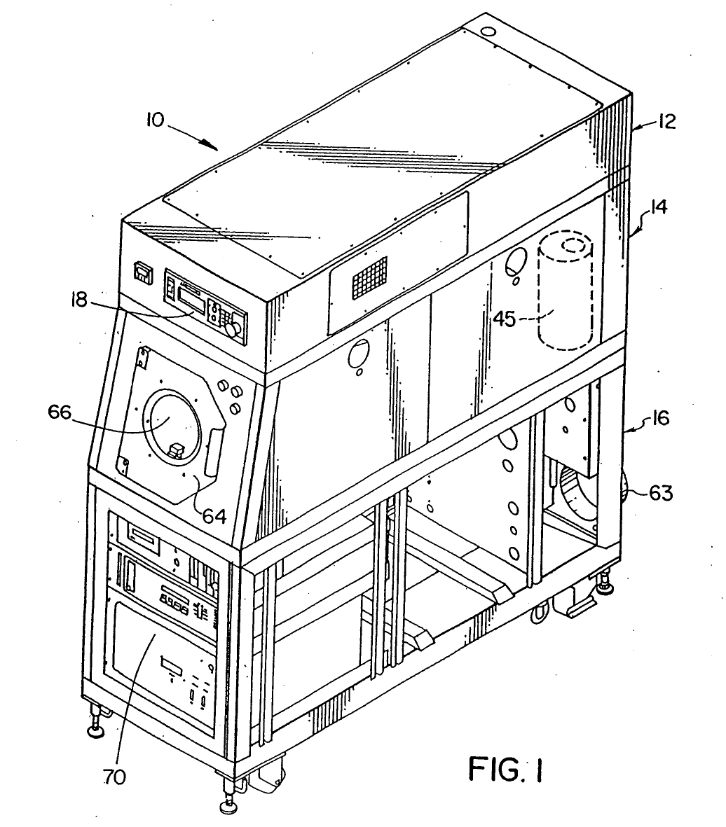

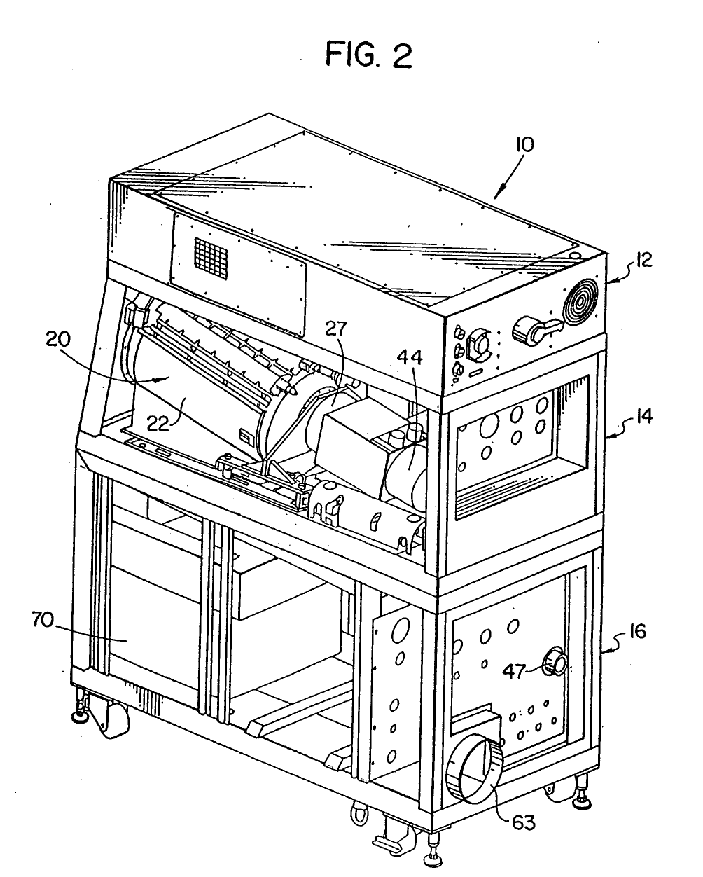

Turning now in detail to the drawings, as shown in FIGS. 1 and 2, a workpiece processing system 10 may include a system controller having a control panel and display 18 at the front of an upper section or first module 12 for controlling and monitoring operation of the system. The first module 12 may also include a system power supply and other electrical components for performing various system operations.

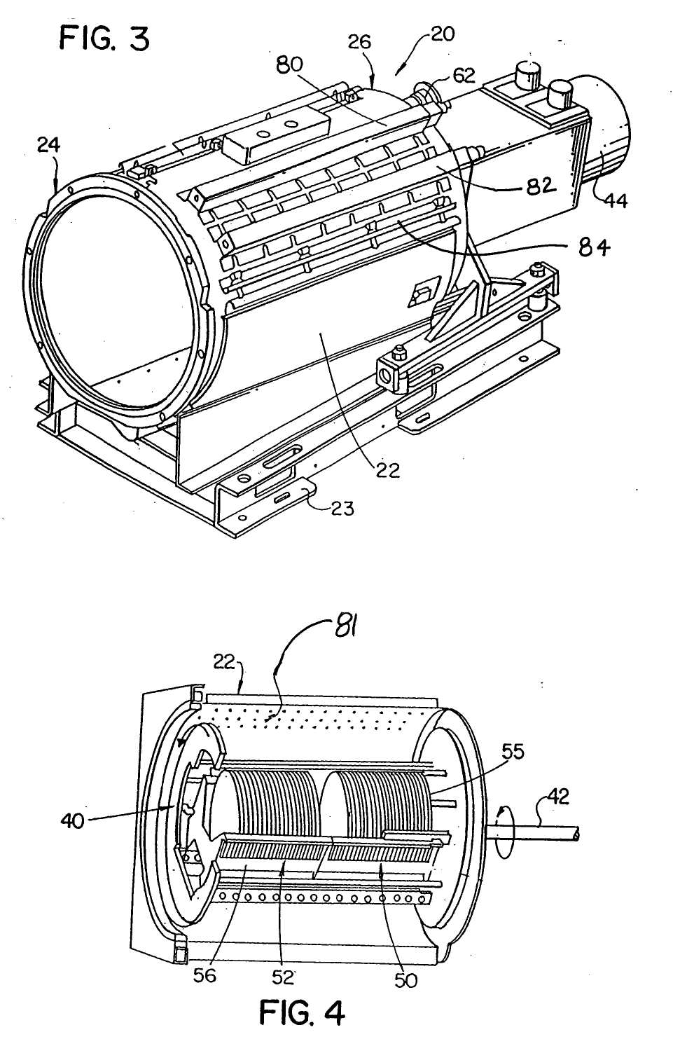

A middle section or module 14 may include a processing chamber assembly 20, as illustrated in FIGS. 2 and 3. The processing chamber assembly 20 includes a processing chamber 22 or bowl that is mounted to the second module 14 via support mounts 23. A chamber door 64 preferably forms a seal with a front end 24 of the processing chamber 22. A window 66 may be provided in the door 64 for allowing visual inspection into the processing chamber 22. The processing chamber 22 may be oriented horizontally or inclined upwardly at an angle of, for example, 5-30°, and preferably about 10°, so that the front end 24 of the processing chamber 22 is at a higher elevation than the back end 26 of the processing chamber 22

A rotor 40, as illustrated in FIG. 4, is rotatably supported within the processing chamber 22. A drive shaft 42 extends from the back of the rotor 40 into a motor 44 located at the back end 26 of the processing chamber 22. The back end 26 of the processing chamber 22 may be sealed with a suitable seal assembly 27.

Various types of rotors may be used. Generally, the rotor 40 is designed to hold one or more wafer containers or cassettes. Alternatively, the rotor 40 may be designed to hold wafers directly, without any container or cassette in the rotor. In this case, the rotor may be provided with combs or similar elements for holding the edges of the wafers directly. In either case, the wafers 55 are spaced apart from each other within the rotor, to allow sprayed in liquids and/or gases to contact substantially all surfaces of the wafers 55.

For processing with acids, the rotor 40 and the chamber 22 are made of a corrosion resistant material, such as Teflon (fluorine resins). Other components of the system that may come into contact with acids, or acid vapors, including the containers or cassettes, and the cabinet structure, may similarly be made from these types of materials. Alternatively, external components of the system, having little of no contact with process acids, may be made of e.g., stainless steel, with a plastic or Teflon insert or liner.

As illustrated in FIGS. 3-5, liquids and gases may be applied to wafers in the process chamber 22 via spray nozzles connected to a manifold. In the design shown, a gas manifold 80 supplies gases, such as ozone and nitrogen, to gas spray nozzles 81 in the chamber. De-ionized water may be provided via a de-ionized water manifold 82 and liquid spray nozzles 83. The de-ionized water may be initially heated in a heater 43, and then pumped under pressure to the spray nozzles 83 via a pump 51.

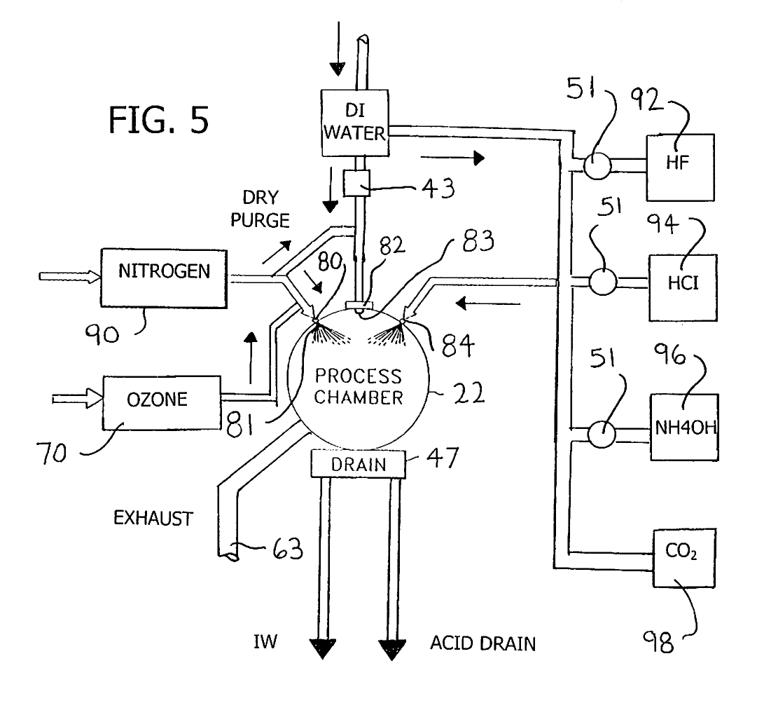

Referring to FIG. 5, liquid chemicals, such as solutions of hydrofluoric acid and hydrochloric acid, may be similarly supplied into the chamber 22 via pumps 51 connecting to a liquid chemical supply manifold 84. A third chemical supply source, such as ammonium hydroxide, may also optionally be included. In an alternative design, both the de-ionized water and the liquid chemicals may be provided from a single manifold connecting to single set of spray nozzles. In this alternative design, only two manifolds are used, one for gases and one for liquids. In other designs, the nozzles may be separately supplied directly, with no manifolds used.

In the chamber 22, the nozzles may be spaced apart along substantially entire length of the processing chamber 22. The manifolds 80, 82 and 84 have spray nozzles or other openings directed into the processing chamber 22 for spraying liquids or gases towards the rotor, generally in a radially inwardly direction. An exhaust duct 63 is preferably included to exhaust gases or vapors from the processing chamber 22. A drain 47 removes liquids from the processing chamber 22.

The processing chamber 22 may further include various other components to enhance processing of the wafers 55. For example, the processing chamber 22 may heaters to heat the workpieces 55 and/or the processing and or rinsing liquids. An anti-static generator may be provided in the nitrogen gas supply to reduce static electricity within the chamber 22.

In the design shown in the drawings, the third module 16 contains an ozone generator 70 connected to the gas spray manifold 80 in the processing chamber 22 via one or more ozone delivery lines. The ozone generator 70 may generate up to 300 gm/cubic meter of ozone, or approximately 90 gm/hour of ozone. As shown in FIG. 5, a nitrogen gas supply 90 is also connected to the gas manifold 80. The nitrogen gas, which may optionally be heated, may be used to purge the chamber 22 of ozone gas, after completion of one or more ozone gas processing steps. The nitrogen may also be used to help dry the wafers. Valves in the gas supply lines connecting to the gas manifold 80 control the flow of gases, and may be linked to the control panel 18, for automated control. A nitrogen gas purge line 91 connects the nitrogen gas supply, through one or more valves, to the de-ionized water manifold, to allow for purging of the manifold and nozzles before drying.

The HF source 92 and the HCl source 94 may be set up to provide ultra-dilute acid. For example, the HF may be diluted down to 1 part source acid to 100 to 1500, 200-1200 or 400 to 1100 parts de-ionized water. Source acid, as used here, means the standard acid as provided by the manufacturer. In the case of HF, source acid is a 49% by weight solution of HF in water. For most applications, the HF concentration ratio (water to acid) may be in the range of 800-1200:1, 900-1100:1, or about 1000:1. Since the source acid is 49% HF, the final actual HF concentration is about 2000:1. The HCl may be provided with similar concentrations. Source hydrochloric acid is a 38% by weight solution of hydrochloric acid in water. Consequently, the final actual HCl concentration is about 3000:1. Correspondingly, the final actual concentrations ranges given above for the source acid (100 to 1500, 200-1200 or 400 to 1100) parts de-ionized water to acid are about 50-3000, 100-2400 or 200-2200 for HF, and about 33-4500, 66-3600 or 130-3300. The claims describe final actual concentrations, regardless of the concentration of the source chemical.

The liquid chemical supplies 92, 94, and 96 of HF, HCl and NH4OH (if used), respectively, may be provided in bulk from sources in the facility, or they may be provided via bottles stored within the system 10. As used here, the term ultra-dilute means 1 part acid (or other chemical as provided by the manufacturer for semiconductor manufacturing use in standard concentration) mixed with at least 100 parts of de-ionized water. Accordingly, with source HF provided at a 49% concentration, ultra-dilute HF is about one part HF to 200 or more parts water. FIG. 5 shows a de-ionized water branch line connecting into the liquid chemical manifold, with the dilution performed using metering pumps 51, along with appropriate valves. However, the ultra-dilute liquid chemicals may also be made elsewhere in the system, or externally. The de-ionized water is generally supplied under pressure from the facility so that no separate de-ionized water pumps are needed.

In use, wafers 55 are typically provided in a container or cassette 54. A standard type of cassette 54 holds 25 200 mm diameter wafers. The door 64 of the processing chamber 22 is opened. One or more cassettes 54 loaded with wafers is placed into the rotor 40, as described in U.S. Pat. No. 6,418,945, incorporated by reference. In the design shown, the rotor 40 is designed to hold two cassettes 54. The door 64 is closed and may generally provide a liquid and gas tight seal with the chamber.

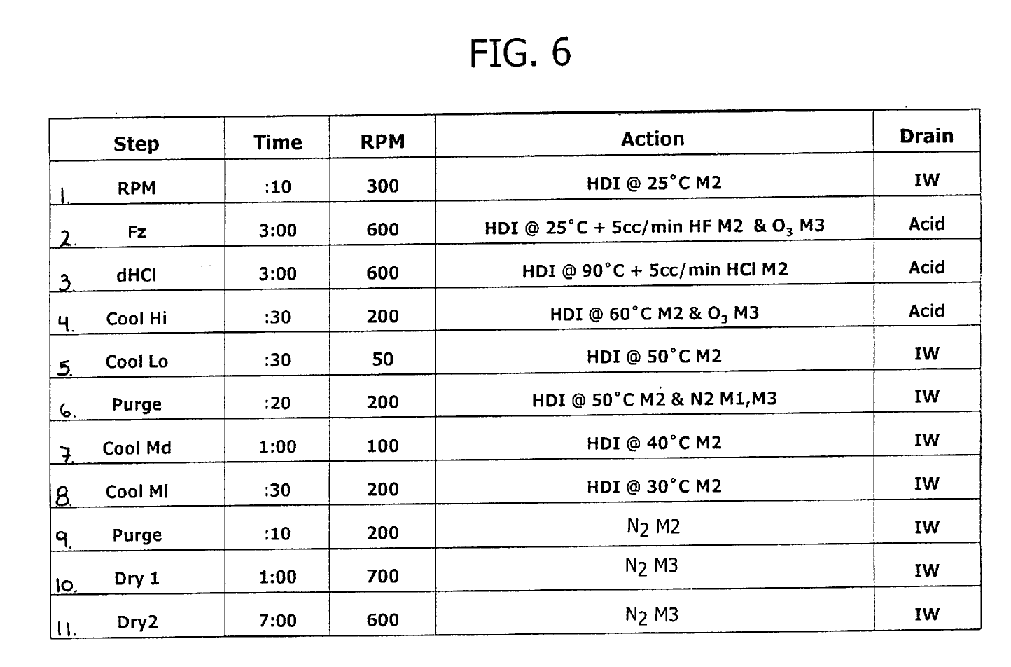

A processing sequence can be preprogrammed into the system controller, or can be set up or selected by the operator using the control panel and display 18. FIG. 6 shows an example of a cleaning process. The duration of each step in minutes and seconds is shown in the Time column of FIG. 6. Similarly, the rotor spin speed in shown in the RPM column. The Drain column indicates whether the liquid drain 47 is connected to an industrial waste drain, or to an acid drain. The liquids and gases used in each step, and the de-ionized water temperatures used, are shown in the Action column.

In a typical cleaning application, for example in front end of the line (FEOL) clean with low silicon loss, in an initial step, the motor 44 is turned on to spin the rotor 44. De-ionized water may then be briefly sprayed onto the spinning wafers via the nozzles 83 of the de-ionized water spray manifold 82. The rotor 44 and cassettes 54 have a generally open structure, allowing liquids and gases sprayed out from the nozzles to directly impact on the wafers.

In step 2 in FIG. 6, while continuing a spray of de-ionized water, a dilute solution of HF is sprayed onto the wafers from the spray nozzles of the liquid chemical manifold 84. At the same time, ozone gas may be sprayed into the chamber. This provides an oxidizing cleaning effect, as described in U.S. Pat. No. 6,497,768, incorporated herein by reference. During this step, the HF acts to etch away the oxide layer on the wafer surface and the ozone causes regrowth of a new oxide layer. Contaminants, including metals, are removed. In applications where the amount of silicon or substrate film loss is less important, or in rework applications, step 2 may be extended beyond 3 minutes.

Next, in step 3, the supply of ozone gas is stopped, but without purging the chamber. Hot de-ionized water (at e.g., 30-99° C.) is sprayed onto the spinning wafers along with a dilute solution of HCl. The HCl chemically reacts with the wafer surface in the presence of the remaining ozone gas. This removes metal contaminants from the wafer surface.

In step 4, de-ionized water heated to a lower temperature is sprayed into the chamber along with ozone gas. Step 4 is the final chemical process step. The remaining steps 6-11 are cooling, purging, rinsing and drying steps, and may be varied as desired.

In step 5, still cooler de-ionized water is briefly sprayed onto the wafers. In step 6, the chamber is briefly purged by providing nitrogen gas and de-ionized water into the chamber. Steps 7 and 8 are progressive cooling steps conducted by spraying progressively cooler water onto the spinning wafers. In steps 9-11 the chamber is again briefly purged, and the wafers are sprayed with nitrogen gas while spinning at high speeds, to dry the wafers.

As shown in FIG. 5, the system 10 may alternatively include a source of ammonium hydroxide (NH₄OH). The NH4OH may be provided from a bulk source in the facility or from a bottle 49 contained within the system 10. If used, the concentration of NH₄OH in de-ionized water is preferably very low, on the order of approximately 500-5000:1 or 1000-3000 or about 2000:1 parts DI water to NH₄OH. The addition of NH₄OH is particularly effective in photoresist removal applications, as it generally increases the removal rate of photoresist layers. Use of ammonium hydroxide provides improved particle performance, cleaning efficiency of SiN particles, and removal of anti-reflective coatings. Generally, if used at all in the system 10, the NH4OH is used in a preceding photoresist strip process. The wafers and chamber are then rinsed and purged before any follow cleaning process using HF and HCl is performed. As also shown in FIG. 5, the system may also include a carbon dioxide source 98. With the other liquid chemical sources closed off by valves, carbon dioxide gas may be mixed with de-ionized water and sprayed into the chamber via the spray manifold 84.

The processing system 10 provides several advantages over existing processing systems. First, the system 10 is compact and does not require large amounts of space in a clean room environment in comparison to a wet bench Overall, the processing system 10 also uses less chemicals, in comparison to traditional RCA wet bench cleaning. The processing system 10 also uses much less de-ionized water. For example, consumption of de-ionized water per wafer is 0.34 liter per wafer in the FIG. 6 process, compared to 20.1 liter/wafer in the RCA cleaning process. Consequently, overall chemical and water consumption, and the volume of liquid waste generated, is greatly reduced.

The process in FIG. 6 uses about 0.14 liter/wafer of ozone, and 51 liter/wafer of nitrogen. The RCA process does not use these gases. However, the RCA process does use significant amounts of NH4OH, H2SO4, H2O2 and isopropyl alcohol. These chemicals are not used in the present process. By avoiding use of these additional chemicals, the present process allows for a more simplified system and method, offers lower manufacturing costs, and produces less liquid waste requiring special handling and treatment.

The apparatus and methods described above may reclaim and reuse one or more of the substances used in processing. However, since very low concentrations of chemicals are used. the apparatus and methods may also be economically operated on a single use basis, with out reusing chemicals, and with minimal or no environmental affects. This can provide for a higher level of clean, since potential for contamination from reused chemicals is avoided.

While discussed primarily in relation to silicon wafers, the invention relates as well to similar workpieces, such as flat panel displays, glass masks, rigid disk or optical media, thin film heads, or other workpieces formed from a substrate on which microelectronic circuits, data storage elements, layers, or micro-mechanical/micro-electro-mechanical elements may be formed. These and similar articles are collectively referred to here as a wafer or workpiece.

Thus, novel apparatus and methods have been shown and described. Various changes and substitutions may of course be made without departing from the spirit and scope of the invention. The invention, therefore, should not be limited except by the following claims and their equivalents.

1. A method for processing a batch of wafers, comprising:
A.] loading a batch of wafers into a rotor in a process chamber;
B.] spinning the rotor;
C.] wetting the wafers with de-ionized water;
D.] spraying the wafers in the spinning rotor with an ultra-dilute solution of hydrofluoric acid;
E.] forming a liquid layer of de-ionized water and hydrofluoric acid solution on a surface of each of the wafers;
F.] introducing ozone gas into the process chamber, with ozone gas diffusing through a layer of the heated water on;
G.] spraying de-ionized water heated to a first temperature onto the wafers in the spinning rotor;
H.] spraying the wafers in the spinning rotor with an ultra-dilute solution of hydrochloric acid;
I.] forming a liquid layer of de-ionized water and the hydrochloric acid solution on the surface of the wafers;
J.] purging the ozone gas from the chamber;
K.] spraying the wafers in the spinning rotor with de-ionized water heated to a second temperature lower than the first temperature; and
L.] drying the wafers.

2. The method of claim 1 with the ultra-dilute hydrofluoric acid at a concentration ratio of water to hydrofluoric acid ranging from 500:1 to 2000:1.

3. The method of claim 1 with the ultra-dilute hydrochloric acid at a concentration ratio of water to hydrochloric acid ranging from 250:1 to 2400:1.

4. The method of claim 2 with the ultra-dilute hydrofluoric acid and the ultra-dilute hydrochloric acid each having a concentration in water of 400-2200:1.

5. The method of claim 1 wherein the first temperature ranges from 30 to 99° C.

6. The method of claim 1 wherein the first temperature ranges from 60-99° C.

7. The method of claim 6 wherein the second temperature ranges from 20-55° C.

8. The method of claim 1 further comprising spraying the ozone and the nitrogen into the chamber from a first manifold, spraying the de-ionized water into the chamber from a second manifold, and spraying the ultra-dilute acids into the chamber from a third manifold.

9. The method of claim 1 further comprising spinning the rotor in steps B and C at more than 500 rpm.

10. The method of claim 1 further comprising supplying ozone into the chamber to an ozone concentration of at least 200 g/m³

11. The method of claim 1 further comprising destroying ozone gas purged from the chamber.

12. The method of claim 1 further comprising providing ultra-dilute acid in steps B and C at a flow rate of 2-8 cc/minute.

13. The method of claim 1 further comprising collecting liquid waste from the chamber in an acid drain, in steps B, C and D, and collecting liquid waste from the chamber during all other steps in a facility drain.

14. The method of claim 1 wherein the wafers are unpatterned silicon wafers.

15. The method of claim 1 wherein step B is performed for 2-6 minutes.

16. A method for processing a workpiece, comprising:
placing the wafer into a rotor in a process chamber;
spinning the rotor;
spraying the wafer in the spinning rotor with de-ionized water and ultra-dilute hydrofluoric acid;
introducing ozone gas into the process chamber;
spraying the wafer in the spinning rotor with an ultra-dilute solution of hydrochloric acid;
purging the ozone gas from the chamber;
rinsing the wafer; and
drying the wafer.

17. The method of claim 16 wherein the concentration of the ultra-dilute hydrofluoric acid is 250 to 2400 parts water to 1 part acid.

18. The method of claim 16 wherein the ozone gas, and the ultra-dilute acids are the only chemicals used in the process.

19. A system for cleaning wafers, comprising:
a non-metal process chamber;
a non-metal rotor in the process chamber for holding and rotating at least one wafer;
first, second and third spray manifolds having nozzles directed towards the rotor;
an ozone gas source connecting into the first spray manifold;
a nitrogen gas source connecting into the first spray manifold;
a de-ionized water source connecting into the second spray manifold;
an ultra-dilute source of hydrofluoric acid connecting into the third manifold;
an ultra-dilute source of hydrochloric acid connecting into the third manifold;
an ozone destructor connected to the process chamber; and
a heater for heating water from the de-ionized water source.

20. The system of claim 19 further comprising first and second drains connected to the process chamber, and a valve to direct liquids drained from the process chamber into the first drain or into the second drain.
